(19) United States
(12) Patent Application Publication
(10) Pub. No.: US 2026/0022707 A1
(43) Pub. Date: Jan. 22, 2026

(54) THREE-DIMENSIONAL AIRFOIL AND METHOD OF CONSTRUCTION

(71) Applicant: Greenheck Fan Corporation, Schofield, WI (US)

(72) Inventors: Rick L. Johnson, Marathon, WI (US); Shamus Doran, Kronenwetter, WI (US); Vijaya Kumar Kollipara, Weston, WI (US); Timothy Twohig, Schofield, WI (US); Duncan Sparks, Schofield, WI (US)

(21) Appl. No.: 19/273,995

(22) Filed: Jul. 18, 2025

Related U.S. Application Data
(60) Provisional application No. 63/673,491, filed on Jul. 19, 2024.

(51) Int. Cl. F04D 29/30; F04D 29/28; F04D 29/32; F04D 29/38

(52) U.S. Cl. CPC F04D 29/30; F04D 29/281; F04D 29/325; F04D 29/384; F05D 2230/232; F05D 2240/301; F05D 2300/10; F05D 2300/43

(57) ABSTRACT

An airfoil designed for fan wheel assemblies fabricated from materials such as metal alloys, and nonstructural, moldable components capable of forming three-dimensional shapes. Techniques for construction include stamping metal blanks to achieve precise aerodynamic profiles and molding processes to encapsulate the structural component, enhancing design flexibility and environmental resilience. Embodiments allow for the integration of features like voids for functional elements, contributing to the airfoil's utility. Embodiments facilitate cost-effective production, adhere to safety standards, and offer retrofit solutions for existing fan assemblies. Collectively, the disclosed embodiments provide a versatile and performance-oriented approach to airfoil design.

### RELATED APPLICATION INFORMATION

This application claims the benefit of U.S. Provisional Application No. 63/673,491, filed Jul. 19, 2024, the contents of which are fully incorporated herein by reference.

### TECHNICAL FIELD

The present disclosure relates generally to the manufacturing of components for HVAC systems, and more particularly to fan blades, airfoil blades, propellers, impellers, stators, and methods for their construction.

### BACKGROUND

Within the HVAC industry, improvements in design and manufacture of fan blades, airfoil blades, propellers, impellers, and stators serve to enhance the efficiency and effectiveness of air handling systems. Specifically, the complex three-dimensional airfoil shapes of these structures can have a significant effect on airflow and energy consumption. In some cases, these structures have been produced using polymers due to their ease of shaping and manufacturing flexibility. However, polymer-based impellers often do not meet more stringent regulatory standards related to flame and smoke propagation.

In other cases, where metal is used, the structure is often constructed of a single thin sheet of metal formed into a three-dimensional shape of uniform thickness. While these types of metal-based impellers are able to meet more stringent regulatory standards, their three-dimensional shape is typically limited by its uniform thickness, which can affect the aerodynamic efficiency and structural integrity of the components. There are also manufacturing limitations, including the ability to bend sheets of metal to meet the desired bend radii, particularly along the trailing edge of an impeller. The use of solid metal or areas of increased thickness can have weight disadvantages, particularly in high-speed rotational environments.

### SUMMARY

Aspects of the present disclosure provide methods for constructing both two- and three-dimensional fan blades, airfoil blades, propellers, impellers, and stator blades (collectively referred to herein as “airfoils”) from materials that meet or exceed HVAC standards with complex three-dimensional shapes aimed at improving airflow and energy consumption. In some embodiments, the structures can be formed of a first material to provide a rigid support structure, such as a metallic alloy, and a second material, such as a moldable composite or polymeric material, for forming the desired three-dimensional aerodynamic contours. Additionally, in some embodiments, the application of various manufacturing techniques can introduce an economically advantageous production method, capable of generating complex airfoil shapes, thereby offering a superior alternative to traditional manufacturing techniques.

One aspect of the present disclosure provides an airfoil for moving air, which can include a first portion of an airfoil formed by stamping a first metal blank to create an inside surface having a first three-dimensional shape, a second portion of the airfoil formed by stamping a second metal blank to create an outside surface having a second three-dimensional shape, wherein the first portion and the second portion are shaped to align precisely with each other along at least a leading edge, and wherein the first portion and the second portion can be joined to one another along the leading edge and a trailing edge of at least one of the first portion or the second portion.

In one aspect, both the first three-dimensional shape and the second three-dimensional shape can be characterized by a compound curvature, defining respective inside and outside curves along both a length and a width of the airfoil.

In one aspect, the first metal blank and the second metal blank can be selected from a material that is suitable for stamping into a complex three-dimensional shape.

In one aspect, a material selected for the first metal blank and the second metal blank can include aluminum, steel, and their alloys.

Another aspect of the present disclosure provides a method for constructing an airfoil, including: stamping a first metal blank using a first stamping die to form a first portion of an airfoil, wherein the first portion corresponds to an inside surface having a first three-dimensional shape; stamping a second metal blank using a second stamping die to form a second portion of the airfoil, wherein the second portion corresponds to an outside surface having an second three-dimensional shape, aligning the first portion and the second portion of the airfoil along their respective leading edges; and joining the aligned first and second portions along at least their respective leading edges, wherein the inside surface and the outside surface complement one another to form a three-dimensional airfoil shape.

In one aspect, the first metal blank and the second metal blank can be selected from a material that is suitable for stamping into a complex three-dimensional shape.

In one aspect, joining of the aligned first and second portions along at least their respective leading edges can be accomplished by welding.

In one aspect, the method can further include joining the first portion to the second portion along a trailing edge of at least one of the first portion or the second portion.

In one aspect, the method can further include performing a finishing operation on the airfoil, including at least one of grinding, polishing, or applying a surface treatment.

Another aspect of the present disclosure provides composite airfoil for use in fan wheel assemblies, including a first component composed of a first material; and a second component composed of a second material capable of assuming a three-dimensional shape, wherein the second component is configured to mechanically couple with the first component through an interlocking mechanism to form a composite structure.

In one aspect, the first material can be at least one of aluminum, steel, or an alloy thereof.

In one aspect, the second material can possess binding properties.

In one aspect, the second component can attach as a layer at least partially surrounding the first component.

In one aspect, the interlocking mechanism between the first and second components can include at least one of a cutout, tab, or webbing.

In one aspect, the composite airfoil can further include one or more voids defined within the second component.

In one aspect, the first component can include one or more tabs configured to facilitate mechanical engagement with at least portions of an wheel shroud, wheel hub or wheel cone.

In one aspect, the composite airfoil can exhibit distinct surface qualities or textures contributed by both the first and second components to enhance airflow characteristics across an external surface.

Another aspect of the present disclosure provides a composite airfoil for use in fan wheel assemblies, including a first component composed of a first material; and a second component composed of a second material capable of assuming a three-dimensional shape, wherein the second component is permanently bonded to the first component to form a unified composite airfoil structure.

In one aspect, the first material can be at least one of aluminum, steel, or an alloy thereof.

In one aspect, the second material can possess binding properties.

In one aspect, the second component can attach as a layer at least partially surrounding the first component.

In one aspect, the interlocking mechanism between the first and second components can include at least one of a cutout, tab, or webbing.

In one aspect, the composite airfoil can include one or more voids defined within the second component.

In one aspect, the first component can include one or more tabs configured to facilitate mechanical engagement with at least portions of an wheel shroud, wheel hub or wheel cone.

In one aspect, the composite airfoil can exhibit distinct surface qualities or textures contributed by both the first and second components to enhance airflow characteristics across an external surface.

Another aspect of the present disclosure provides a composite airfoil for use in fan wheel assemblies, including a first component composed of a first material; and a two-part second component composed of a second material capable of assuming a three-dimensional shape, the two-part second component configured to be mechanically coupled to each side of the first component to encapsulate the first component and form a unified composite airfoil structure.

In one aspect, the first material can be at least one of aluminum, steel, or an alloy thereof.

In one aspect, the second material can possess binding properties.

In one aspect, the two-part second component can attach as a layer at least partially surrounding the first component.

In one aspect, the interlocking mechanism between the first component and the two-part second component can include at least one of a cutout, tab, or webbing.

In one aspect, the composite airfoil can include one or more voids defined within the second component.

In one aspect, the first component can include one or more tabs configured to facilitate mechanical engagement with at least portions of an wheel shroud, wheel hub or wheel cone.

In one embodiment, the composite airfoil can exhibit distinct surface qualities or textures contributed by both the first component and the two-part second component to enhance airflow characteristics across an external surface.

Another aspect of the present disclosure provides an airfoil for use in a fan assembly, including a first component formed from a metallic material and defining a primary structural support for the airfoil, the first component including a leading edge portion and extending aft of the leading edge portion to define a trailing region of the airfoil; and a second component formed from a moldable, nonstructural material and disposed along a leading edge region of the airfoil. The second component defines a compound curved leading edge configured to serve as an aerodynamic nose of the airfoil; a compound curved channel configured to receive and retain the leading edge portion of the first component; and a chamfer portion extending aft of the compound curved leading edge and blending with an outer surface of the first component, the chamfer portion providing an acrodynamic blade chamfer with a depth greater than a thickness of the first component. The first component is mechanically retained within the channel of the second component via at least one of adhesive bonding, friction fit, thermal welding, or mechanical interlock, such that the second component assumes a primary aerodynamic role at the leading edge region, while the first component provides structural rigidity along an aft region of the airfoil.

Another aspect of the present disclosure provides an axial fan wheel assembly including an axial fan wheel hub and a plurality of radial spoke elements extending outward from the axial fan wheel hub. Each radial spoke element includes a neck portion extending radially outward from the axial fan wheel hub and an airfoil interface portion located at a distal end of the neck portion, the airfoil interface portion including a mounting surface oriented at an angle configured to define a pitch or angle of attack for an airfoil. The axial fan wheel assembly further includes a plurality of airfoils circumferentially coupled to the axial fan wheel hub via respective airfoil interface portions of the spoke elements. Each airfoil includes a first component formed from a thin metal sheet and defining a structural backbone of the airfoil, the first component including at least one structural feature selected from the group consisting of a ridge, corrugation, or contour extending along a chordwise or spanwise direction of the airfoil; and a second component formed from a moldable material and conformally disposed on the first component to define an aerodynamic outer surface of the airfoil. Each first component is mechanically fastened or bonded to a corresponding airfoil interface portion of one of the spoke elements to mechanically couple the airfoil to the axial fan wheel hub.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a assembled fan wheel, in accordance with an embodiment of the disclosure.

FIG. 2 is a perspective view depicting a first metal blank for use in construction of a first portion of an airfoil, in accordance with an embodiment of the disclosure.

FIG. 3 is a perspective view depicting a second metal blank for use in construction of a second portion of an airfoil, in accordance with an embodiment of the disclosure.

FIG. 4 is a perspective view depicting a first stamping die for use in formation of an inside surface of an airfoil, in accordance with an embodiment of the disclosure.

FIG. 5 is a perspective view depicting a second stamping die for use in formation of an outside surface of an airfoil, in accordance with an embodiment of the disclosure.

FIG. 6 is a perspective view depicting a first portion of an airfoil defining an inside surface having a first three-dimensional shape, in accordance with an embodiment of the disclosure.

FIG. 7 is a perspective view depicting a second portion of an airfoil defining an outside surface having a second three-dimensional shape, in accordance with an embodiment of the disclosure.

FIG. 8 is a perspective view depicting a combination of the first portion of FIG. 5 and the second portion of FIG. 6 to form an airfoil having a three-dimensional airfoil shape, in accordance with an embodiment of the disclosure.

FIG. 9 is a perspective view depicting an assembled airfoil including one or more welded seams, and accordance with an embodiment of the disclosure.

FIG. 10 is a partial, perspective, exploded view of a fan wheel including an airfoil, in accordance with an embodiment of the disclosure.

FIG. 11 is a cross-sectional, perspective view of the fan wheel of FIG. 1, in accordance with an embodiment of the disclosure.

FIG. 12 is a perspective view of an airfoil of the fan wheel of FIG. 1, in accordance with an embodiment of the disclosure.

FIG. 13 is a cross-sectional, perspective view of the airfoil of FIG. 12, showing a first cross-section plane extending along the x- and y-axes.

FIG. 14 is a perspective view of an airfoil of the fan wheel of FIG. 1, in accordance with an embodiment of the disclosure.

FIG. 15 is a cross-sectional, perspective view of the airfoil of FIG. 14, showing a second cross-sectional plane extending along the x- and z-axes, wherein the second cross-sectional plane is substantially orthogonal to the first cross-sectional plane.

FIG. 16 is a profile view depicting a fan wheel including a composite airfoil having first and second components, in accordance with an embodiment of the disclosure.

FIG. 17 is a perspective view of the first component of the composite airfoil of FIG. 16, in accordance with an embodiment of the disclosure.

FIG. 18 is a perspective view of the second component of the composite airfoil of FIG. 16, in accordance with an embodiment of the disclosure.

FIG. 19 is a perspective view of a composite airfoil comprising the first component of FIG. 17 and the second component of FIG. 18.

FIG. 20 is a perspective view of a second component of a composite airfoil, in accordance with an embodiment of the disclosure.

FIG. 21 is an alternate perspective view of the second component of FIG. 20, in accordance with an embodiment of the disclosure.

FIG. 22 is a perspective view of a composite airfoil including the second component of FIG. 20, in accordance with an embodiment of the disclosure.

FIG. 23 is a perspective view of the second component of a composite airfoil, in accordance with an embodiment of the disclosure.

FIG. 24 is an alternate perspective view of the second component of FIG. 23, in accordance with an embodiment of the disclosure.

FIG. 25 is a perspective view of a composite airfoil including the second component of FIG. 23, in accordance with an embodiment of the disclosure.

FIG. 26 is a perspective view of the second component of a composite airfoil, in accordance with an embodiment of the disclosure.

FIG. 27 is an alternate perspective view of the second component of FIG. 26, in accordance with an embodiment of the disclosure.

FIG. 28 is a perspective view of a composite airfoil including the second component of FIG. 26, in accordance with an embodiment of the disclosure.

FIG. 29 is a perspective view depicting a fan wheel including a composite airfoil having a strut and body component, in accordance with an embodiment of the disclosure.

FIG. 30 is a perspective, cross-sectional view depicting the fan wheel of FIG. 29, in accordance with an embodiment of the disclosure.

FIG. 31 is a close-up, perspective, cross-sectional view of a composite airfoil having first and second components of the fan wheel of FIG. 29, in accordance with an embodiment of the disclosure.

FIG. 32 is a perspective view of a composite airfoil, in accordance with an embodiment of the disclosure.

FIG. 33 is a top perspective view of the composite airfoil of FIG. 32, in accordance with an embodiment of the disclosure.

FIG. 34 is a perspective view depicting a fan wheel including a composite airfoil having a strut and two-piece clamshell body components, in accordance with an embodiment of the disclosure.

FIG. 35 is a perspective, cross-sectional view depicting the fan wheel of FIG. 34, in accordance with an embodiment of the disclosure.

FIG. 36 is a close-up, perspective, cross-sectional view of a composite airfoil having first and second components of the fan wheel of FIG. 34, in accordance with an embodiment of the disclosure.

FIG. 37 is a perspective view of a composite airfoil, in accordance with an embodiment of the disclosure.

FIG. 38 is an alternate perspective view of the composite airfoil of FIG. 37, in accordance with an embodiment of the disclosure.

FIG. 39 is a top perspective view of the composite airfoil of FIG. 37, in accordance with an embodiment of the disclosure.

FIG. 40 is a first perspective view of an axial fan assembly incorporating one or more airfoils, in accordance with an embodiment of the disclosure.

FIG. 41 is a second perspective view of the axial fan assembly of FIG. 40.

FIG. 42 is a first perspective view of an axial fan assembly incorporating one or more airfoils, in accordance with an embodiment of the disclosure.

FIG. 43 is a cross sectional view of the axial fan assembly of FIG. 42.

FIG. 44 is a perspective, cross-sectional view of a fan assembly including one or more airfoils serving as struts or stators, in accordance with an embodiment of the disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

### Concept I

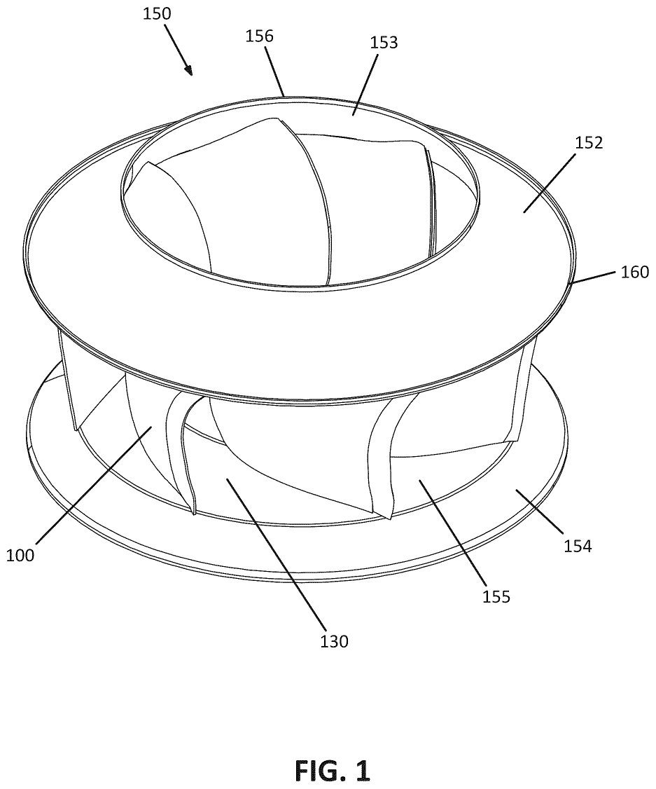

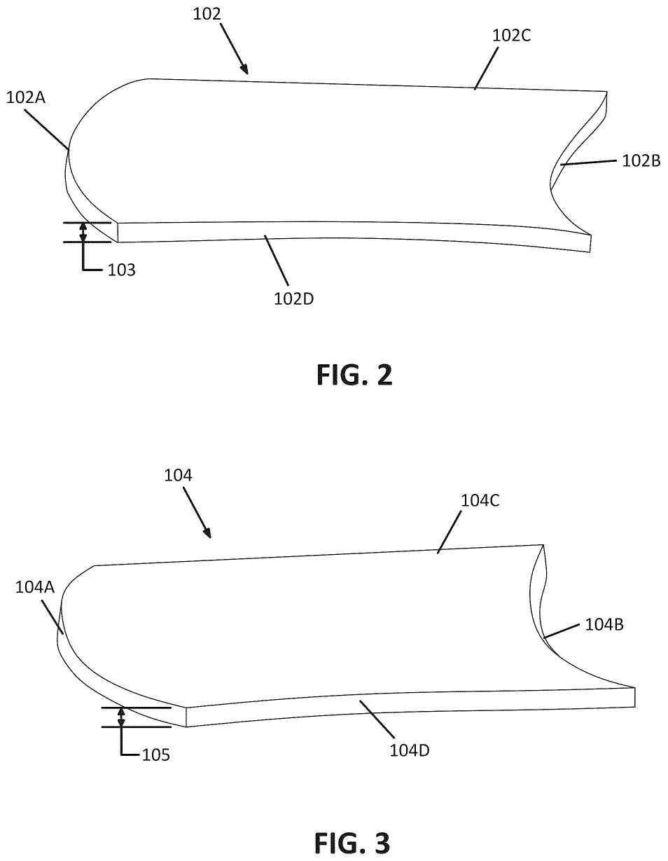

Referring to FIG. 1, a depiction of a fan wheel 150 is provided, incorporating a plurality of composite three-dimensional airfoils 100. Referring to FIGS. 2-3, perspective views of a first metal blank 102 and a second metal blank 104 are depicted, each initially provided as flat cutouts derived from a larger sheet of metal. These blanks serve as the foundational elements for the construction of a composite three-dimensional airfoil 100 intended for air movement. For example, the first metal blank 102 can be used in forming an inner surface of an airfoil blade, while the second metal blank 104 can be used in forming the outer surface of the airfoil blade.

The first metal blank 102 is characterized by edges 102A-D, which may be either curved, straight, or a combination thereof. This first metal blank 102 also possesses a specified thickness 103, having capacity for deformation into a three-dimensional airfoil shape through processes such as stamping, leveraging its inherent malleability. The second metal blank 104 is characterized by edges 104A-D, which, akin to the first metal blank, may exhibit curved, straight, or composite profiles. The second metal blank 104 also maintains a thickness 105, ensuring an optimal equilibrium between moldability for shaping and structural resilience for enduring operational demands.

Initially, the preparation of the first metal blank 102 and the second metal blank 104 as flat cutouts facilitates the crafting of complex geometries for the airfoil blade's design. The selection of materials for these blanks can be based on the material's malleability for achieving a desired double-curved design without compromising the blade's structural integrity. In some embodiments, the selection of materials can be based the desired application, potentially including the material's ability to withstand heightened temperatures or combustion properties.

Materials considered for these blanks include, but are not limited to, aluminum, steel, and their respective alloys. Aluminum is preferred for its lightweight nature, corrosion resistance, and superior formability, making it suitable for complex airfoil configurations. Steel is valued for its strength and durability, providing the airfoil blade with robustness across diverse operational conditions. The engineering of these metals and their alloys aims to refine specific characteristics such as tensile strength, thermal resistance, and formability, further ensuring that the chosen material meets the requisite safety standards and affords the necessary design flexibility for aerodynamically efficient structures.

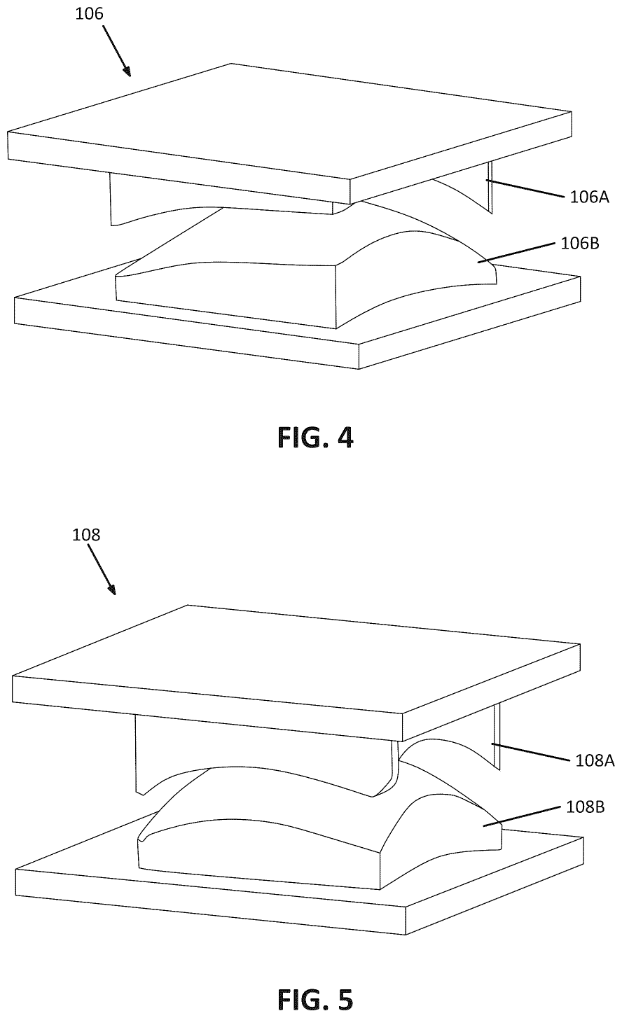

With additional reference to FIGS. 4-5, a first stamping die 106 and a second stamping die 108 are depicted in accordance with embodiments of the disclosure. These dies 106, 108 are respectively used to form the first metal blank 102 and the second metal blank 104 into the components of an airfoil 100. In embodiments, the first stamping die 106 is engineered to transform the first metal blank 102 into a first portion 110, which defines an inside surface 112 of the airfoil 100, embodying a first three-dimensional shape 114. Similarly, the second stamping die 108 can be designed with precision to shape the second metal blank 104 into a second portion 116, which can define an outside surface 118 of the airfoil 100, adopting a second three-dimensional shape 120.

The first stamping die 106 comprises a first portion 106A and a second portion 106B, designed to securely hold the first metal blank 102 therebetween. Once positioned, an external compression force is applied to the first portion 106A and/or the second portion 106B, resulting in the deformation of the first metal blank 102. This deformation process shapes the first metal blank 102 into the first three-dimensional shape 114, defining the inside surface 112 of the airfoil 100 according to design specifications.

Similarly, the second stamping die 108 comprises a first portion 108A and a second portion 108B, which function to shape the second metal blank 104. With the second metal blank 104 placed between the first portion 108A and the second portion 108B, an external compression force is applied. This force deforms the second metal blank 104 into the second three-dimensional shape 120, which forms the outside surface 118 of the airfoil 100. The precise configuration of the second stamping die 108 ensures that the second metal blank 104 is transformed into a shape that complements the first portion 110, facilitating the assembly of an airfoil 100 with the desired acrodynamic characteristics.

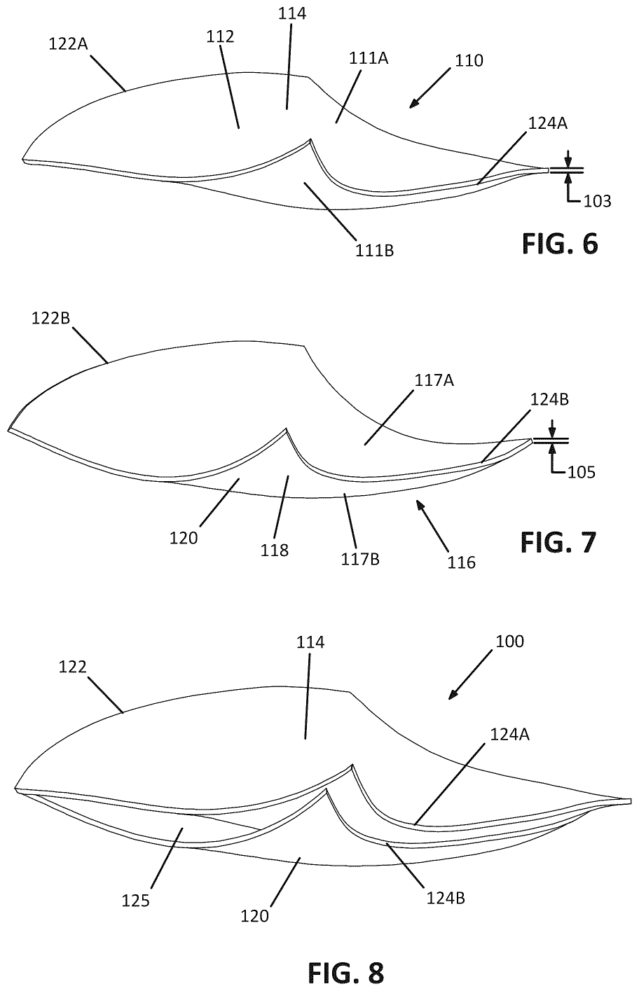

FIG. 6 presents a perspective view of the first portion 110, which includes a first major surface 111A and a second major surface 111B, separated by a thickness 103. The first major surface 111A defines the inside surface 112, showcasing a first three-dimensional shape 114, integral to the internal acrodynamic profile of the airfoil 100. FIG. 7 depicts a perspective view of the second portion 116, which includes a first major surface 117A and a second major surface 117B, separated by a thickness 105. The second major surface 117B defines the outside surface 118, incorporating a second three-dimensional shape 120 for the airfoil blade's external aerodynamic characteristics.

FIG. 8 illustrates the assembly of the first portion 110, as shown in FIG. 8, with the second portion 116, as depicted in FIG. 7, to constitute an airfoil 100 defining a comprehensive three-dimensional airfoil shape 101. In some embodiments, the first portion 110 and the second portion 116 are aligned along a leading edge 122 and, where applicable, along a trailing edge 124. As depicted, the leading edge 122A of the first portion 110 can align with a leading edge 122B of the second portion 116, facilitating a junction for mechanical coupling (e.g., a scam, etc.), thereby securing the first portion 110 to the second portion 116.

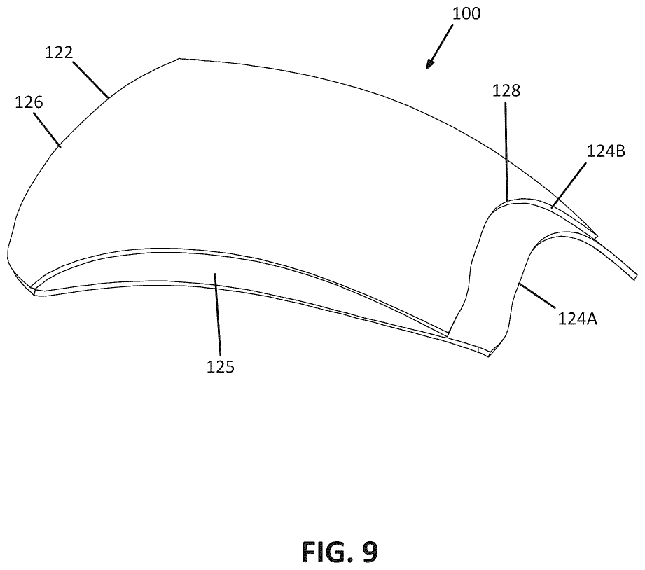

FIG. 9 illustrates a first welded seam 126 positioned along the leading edge 122. FIG. 9 also illustrates a second welded seam 128 positioned along a trailing edge 124B of the second portion 116. This arrangement allows for the second welded seam 128 to be placed along a second major surface 111B of the first portion 110, while a trailing edge 124A of the first portion 110 projects beyond the trailing edge 124B of the second portion 116. In some embodiments, a gap 125 or void may be established between the first portion 110 and the second portion 116, contributing to the structural and aerodynamic design of the airfoil blade. In some embodiments, the protruding trailing edge 124A of the first portion 110 can undergo conditioning, such as being sharpened, coined, or otherwise furnished with a beveled edge, to enhance the airflow characteristics associated with the airfoil blade's trailing edge.

In some embodiments, an intermediate alignment feature may be incorporated between the first portion 110 and the second portion 116 during assembly. For example, one or more locating tabs, dimples, or recessed channels may be formed into either or both of first three dimensional shape 114 and the second three dimensional shape 120 during the stamping process. These features can assist in maintaining precise alignment during welding or bonding, especially along compound curved regions of the airfoil 100. Additionally, a structural insert, such as a lightweight metallic or polymeric core, can be positioned between first three dimensional shape 114 and the second three dimensional shape 120 prior to final joining. The insert can enhance stiffness, dampen vibration, or tailor the acoustic properties of the airfoil during high-speed rotation. In certain embodiments, the insert may define voids or cavities to reduce weight or accommodate functional components such as sensors or balancing masses.

Incorporation into Fan Wheel

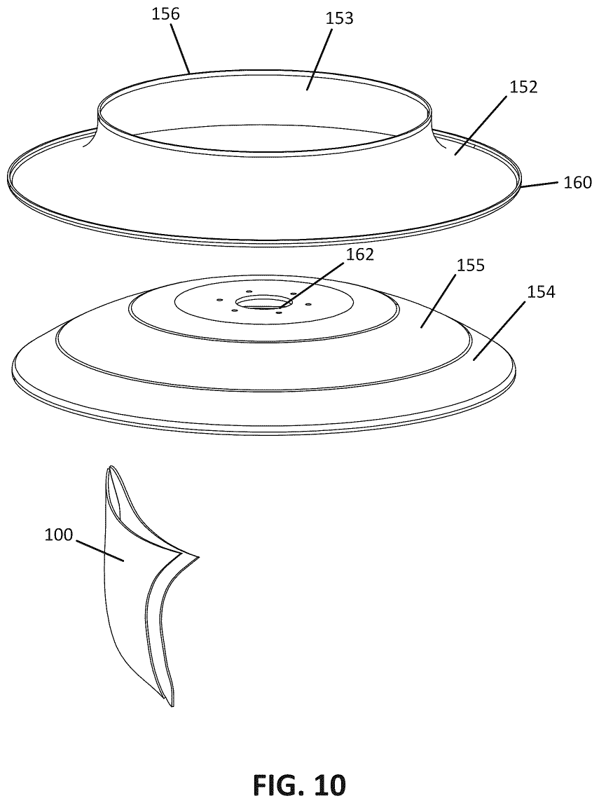

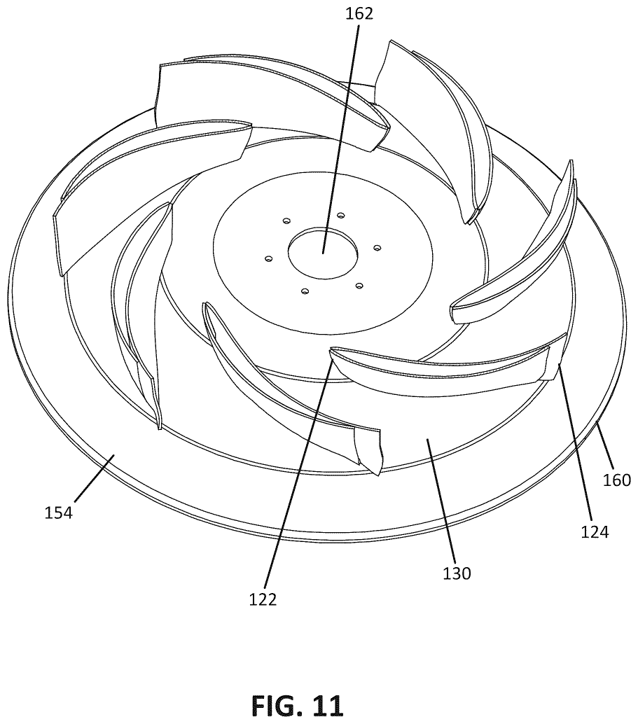

Referring to FIGS. 1, 10 and 11, a fan wheel 150 is depicted, including an wheel shroud 152, a wheel hub 154, and a plurality of airfoils 100. The wheel shroud 152, can be equipped with a first airflow surface 153, which forms a major surface on one side of the wheel shroud 152. The first airflow surface 153 can outline an interior of a wheel cone, adopting a curved, funnel-shaped conical surface that extends from a central air inlet aperture 156 to an outer perimeter 160 of the wheel shroud 152.

The wheel hub 154, can be defined by a second airflow surface 155, representing a major surface on one side of the wheel hub 154. The second airflow surface 155, may assume a conical or frusto-conical shape, signifying the exterior of a cone aligned along the z-axis. For instance, the second airflow surface 155 may form an angle ranging from about 0° to about 60° with the x- or y-axes. Alternatively, the second airflow surface 155 may exhibit a curved or truncated dome-shaped profile. These configurations of the first and second airflow surfaces can aid in moderating a change in airflow direction upon entry into the fan wheel 150. In other embodiments, the first and second airflow surface 153, 155 can be substantially planar.

As depicted, the airfoils 100 are mechanically coupled between the wheel shroud 152 and the wheel hub 154, with a designated space separating the two components. Various shapes and sizes of airfoils 100 are employable to modify the air handling characteristics of the fan wheel 150. Accordingly, while the wheel shroud 152 and wheel hub 154 may adhere to standard dimensions, the specific configuration of the airfoils 100 can be customized to achieve optimal performance for particular applications.

A series of air channels 130 are delineated between the airfoils 100, as depicted. The cooperative arrangement of the first airflow surface 153, the second airflow surface 155, and adjacent airfoils 100 collectively form each air channel 130. These airfoils 100 are positioned with their leading edges 122 near the central air inlet aperture 156 and trailing edges 124 near the outer perimeter 160. The cross-sectional area of each air channel 130 near the leading edge 122 is smaller than at a distance closer to the outer perimeter 160, thereby functioning as a diffuser. Although a configuration with seven airfoils 100 is illustrated, variations in the number of blades are contemplated, acknowledging the possibility of using a greater or fewer quantity to suit different operational needs.

These embodiments promote a progressive enlargement of the air channels 130 towards the blades' outer edges, facilitating a reduction in air velocity and an increase in pressure, hence improving the centrifugal fan's efficiency and reducing noise production. Each air channel 130 acts as a duct where the gradual expansion of the cross-sectional area results in decreased fluid velocity and increased pressure. To enhance this effect, the trailing edge 124 of each airfoil 100 may be curved, expanding the cross-sectional area near the outer perimeter 160 and optimizing airflow dynamics.

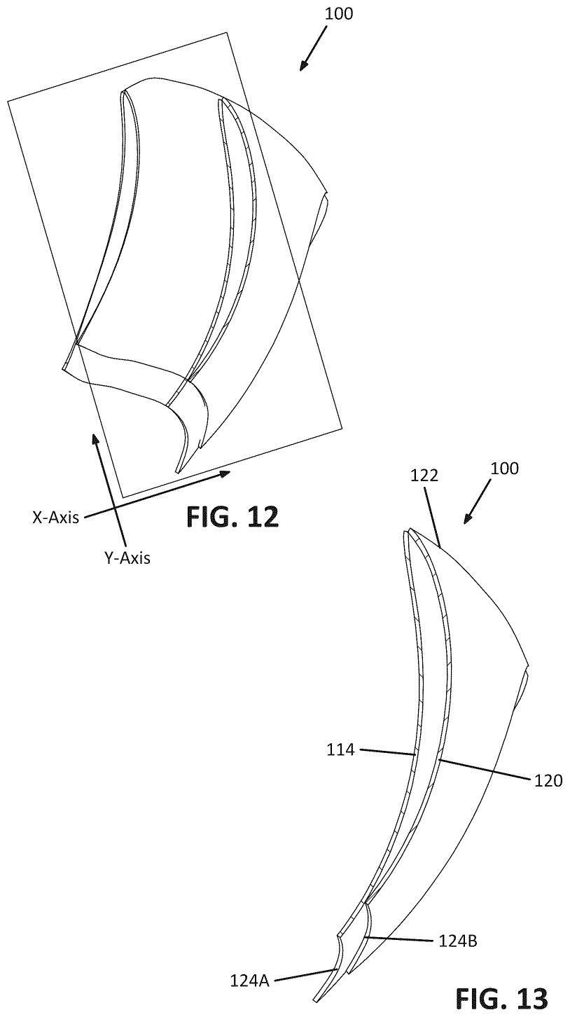

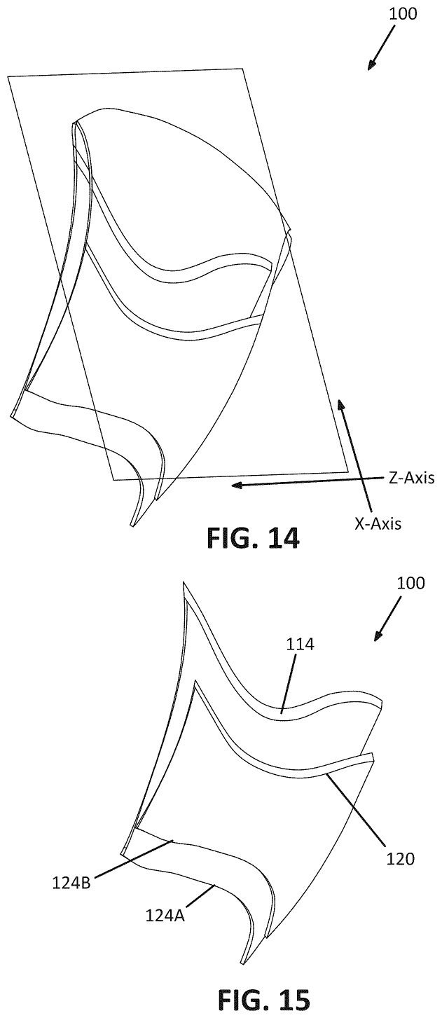

FIGS. 12-15 reveal that each airfoil 100 can possess a complex three-dimensional shape, featuring a compound curvature observable in planes parallel to the x-y axes (as in FIGS. 12-13) and the x-z axes (as in FIGS. 14-15). Additionally, in some embodiments, an asymmetric curvature of the trailing edge 124 can aid in smoother flow separation at the wheel hub 154, as well as a more even pressure distribution across the blade span, leading to a quieter and more energy-efficient airflow through the fan wheel 150.

### Concept II

In certain embodiments, such as that depicted in FIGS. 1-15, the airfoils 100 may be entirely constructed from metallic materials, such as sheet metal, employing the manufacturing techniques herein described. Alternatively, the airfoils 100 may be designed as composite airfoil blades, comprising a first component, constructed of a first material that acts as a robust foundation to support a second component constructed of a second material that is amenable to shaping into a three-dimensional form.

The integration of the second component into the airfoils 100 provides a cost-efficient method for fabricating three-dimensional airfoil configurations. This strategy offers an economical alternative to the methods previously outlined, without sacrificing the structural integrity or operational functionality of the airfoil blades. In embodiments, the three-dimensional conformable second material can serve to lower manufacturing costs, which can be particularly beneficial for applications that demand cost-effectiveness alongside performance and safety. Additionally, this approach provides weight reduction and distribution advantages, contributing to improved aerodynamic characteristics and reduced mechanical stress on the rotating assembly.

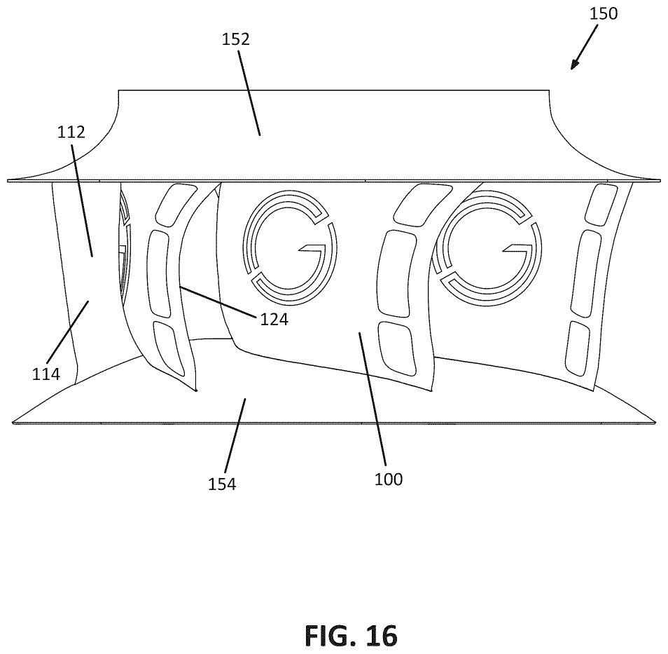

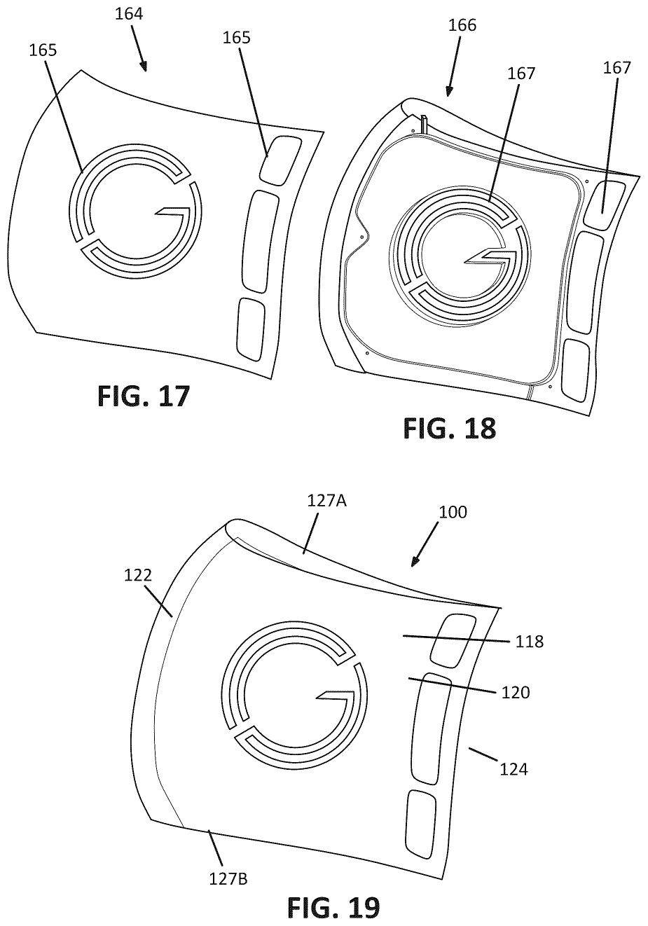

Referring to FIGS. 16-25, a depiction of a fan wheel 150 is provided, incorporating a first component 164 and a second component 166. FIG. 17 depicts the first component 164 of a composite three-dimensional airfoil 100, designed to support a second component 166, as illustrated in FIG. 18. The first component 164 may be constructed from a first material, including but not limited to aluminum, steel, and their alloys, which can be selected for its structural integrity and suitability for airfoil blade design. As a structural material, this first material can be chosen for its high strength-to-weight ratio, durability, and resistance to deformation under operational loads, enabling the first component 164 to bear the mechanical stresses encountered during high speed rotation, and providing a framework for blade assembly. The first component 164 can also feature one or more first features 165, such as material cutouts, to ensure precise engagement with the second component 166.

FIG. 18 depicts the second component 166, made from a second material that can assume a specific three-dimensional shape for the airfoil design. In some embodiments, the second material may possess binding properties that allow it to solidify under specific conditions, such as drying, catalytic reaction, or heat application. The second component 166 can be formed through methods like molding, 3D printing, stamping, casting, extruding or machining, potentially directly onto the first component 164, enabling a unified construction of the composite airfoil 100, allowing for customization to reinforce or eliminate fragile areas of the blade body, simplifying the forming process.

In some embodiments, the second material can be characterized as nonstructural, meaning it is not intended to be the primary load-bearing element of the fan blade assembly. Instead, the second material can be configured to enhance the aerodynamic properties, surface finish, or other specific attributes of the airfoil design. Despite being nonstructural, the second material can still exhibit a high strength-to-weight ratio, durability, and resistance to deformation under operational loads, to ensure that while the second component may not always bear the majority of the mechanical stresses during operation, the second material contributes to the overall performance and longevity of the fan blade.

FIG. 19 displays the combined first component 164 and second component 166, creating the composite three-dimensional airfoil 100. In some embodiments, the combination can be facilitated by a coupling contact between (e.g., an interlocking between) second features 167 of the second component 166 and first features 165 of the first component 164, to securely couple the second component 166 to the first component 164. These contact areas or interlocking mechanism can serve to mitigate the risk of incorrect assembly, ensuring correct alignment and fastening of the components.

Together, the first component 164 and second component 166 can define a composite three-dimensional airfoil 100 with an inside surface 112 featuring a first three-dimensional shape 114, and an outside surface 118 with a second three-dimensional shape 120. As used herein, a “three-dimensional” airfoil refers to an airfoil geometry in which the thickness of the blade varies along its chord—i.e., the cross-sectional profile taken from the leading edge 122 to the trailing edge 124—rather than being defined solely by a flat or uniformly curved plate with constant thickness. This variation in thickness enables the airfoil to achieve acrodynamic shaping that more closely approximates optimized aerodynamic profiles, improving performance characteristics such as lift, drag, and flow stability. The combined inside and outside surfaces 112, 118 can be bounded by a leading edge 122, trailing edge 124, top edge 127A, and bottom edge 127B. As shown in FIG. 16, the top edge 127A and bottom edge 127B can be mechanically joined to a wheel shroud 152 and a wheel hub 154, assembling a fan wheel 150.

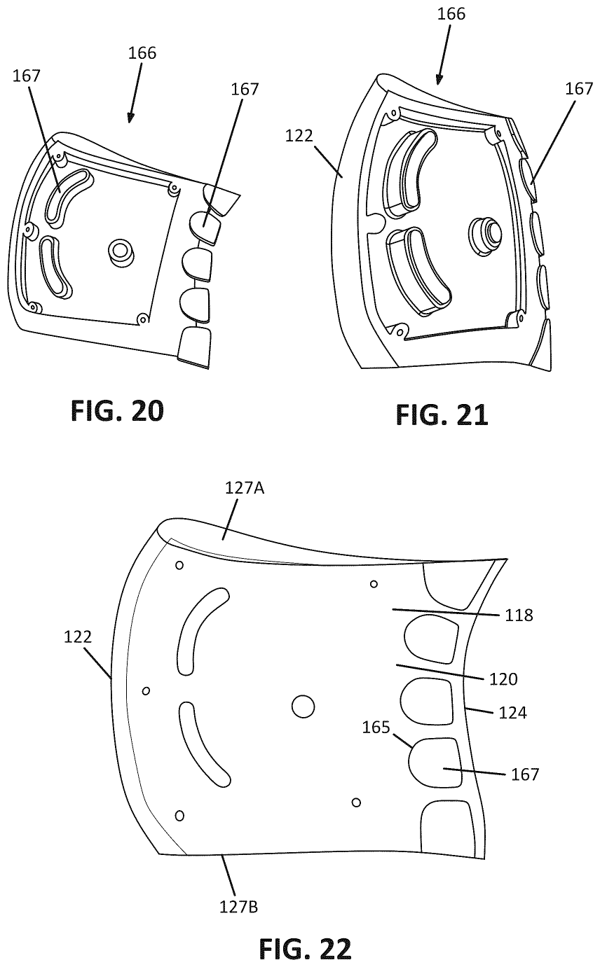

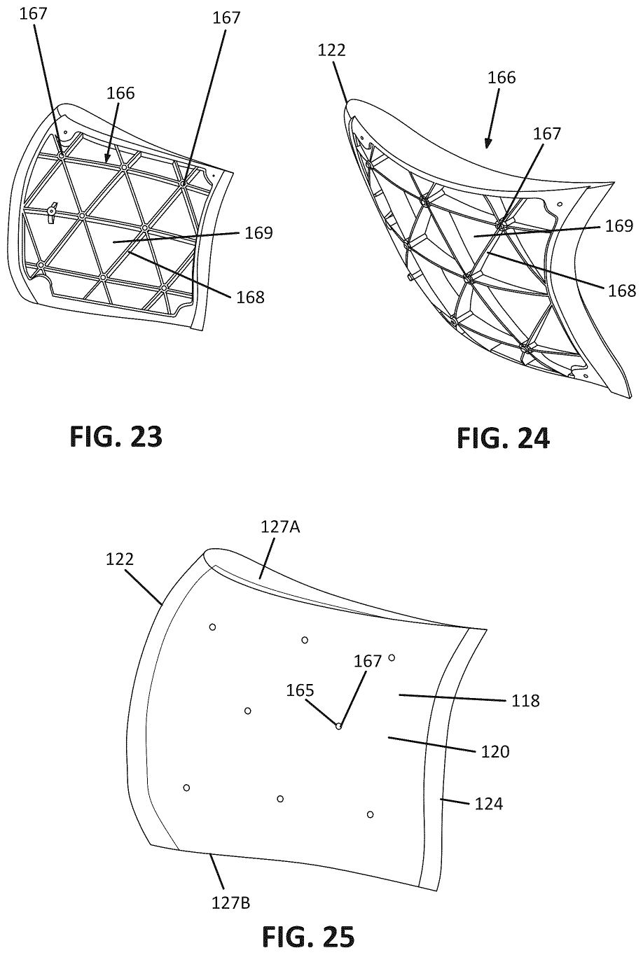

FIGS. 20-22 illustrate a first alternative embodiment of the composite three-dimensional airfoil 100, and FIGS. 23-25 present a second alternative embodiment of the same. In certain embodiments, portions of the second component 166 may penetrate through first features 165 defined by the first component 164, resulting in at least one surface of the airfoil blade—such as the inside surface 112 or the outside surface 118—being conjointly defined by both the first component 164 and the second component 166. This configuration allows for the unique integration of both components to contribute to the aerodynamic profile of the airfoil blade.

Moreover, the first component 164 and the second component 166 may exhibit distinct surface qualities or textures. Consequently, a pattern emergent from the combination of the first component 164 and the second component 166 on any given surface can be designed to enhance airflow characteristics. For instance, as demonstrated in FIG. 22, an embodiment may feature the interlocking of features 165 and 167 near the trailing edge 124 of the airfoil 100, for improved air separation properties. Alternatively, the arrangement of these interlocking features could embody a corporate emblem or a decorative motif, adding aesthetic value or brand identification to the design.

In embodiments showcased in FIGS. 23-24, the second component 166 can be designed to include webbing or additional structural supports 168, which may also define one or more voids 169. These supports and voids can mitigate stress concentrations, enhancing the structural resilience of the airfoil blade. In some embodiments, the second component 166 can also form the trailing edge 124 of the composite three-dimensional airfoil 100. The incorporation of voids 169 offers the utility of housing balancing weights, RFID chips, mechanical actuators, sensors, or other functional elements, thereby extending the versatility and application beyond its aerodynamic and structural functions.

In some embodiments, there exists the possibility for the integration of the second component 166 into pre-existing bladed fan assemblies, thereby augmenting their efficiency. This incorporation can be realized as a retrofit add-on, designed to enhance airflow efficiency within the system. Specifically, the second component 166, characterized by its ability to be shaped into various three-dimensional forms, can be coupled to the blades of existing fans. Such an adaptation can serve to further improve the acrodynamic properties of the fan blades, subsequently leading to efficiency improvements in existing systems.

In some embodiments, the second component 166 can define a recess—such as a groove, pocket, or cavity between second features 167—that is shaped and sized to receive the leading portion of the first component 164. When the first component 164 is inserted into this recess, the mating surfaces of the two components can form a substantially flush and smooth surface that is free of ridges, steps, or seams at the interface between the first and second components. This seamless integration enhances the aerodynamic quality of the blade and reduces turbulence-inducing surface irregularities. In such embodiments, a first three-dimensional shape 114 corresponding to a first camber side of the airfoil 100 may be defined entirely by the second component 166 or jointly by the second component 166 and the first component 164. Conversely, a second three-dimensional shape 120 representing a second, opposite camber side of the airfoil 100 may be defined entirely by the first component 164 or by a combination of the first and second components 164, 166. This flexibility in structural and acrodynamic surface definition enables the designer to strategically allocate materials and functions between the two components based on performance, manufacturing, or cost considerations.

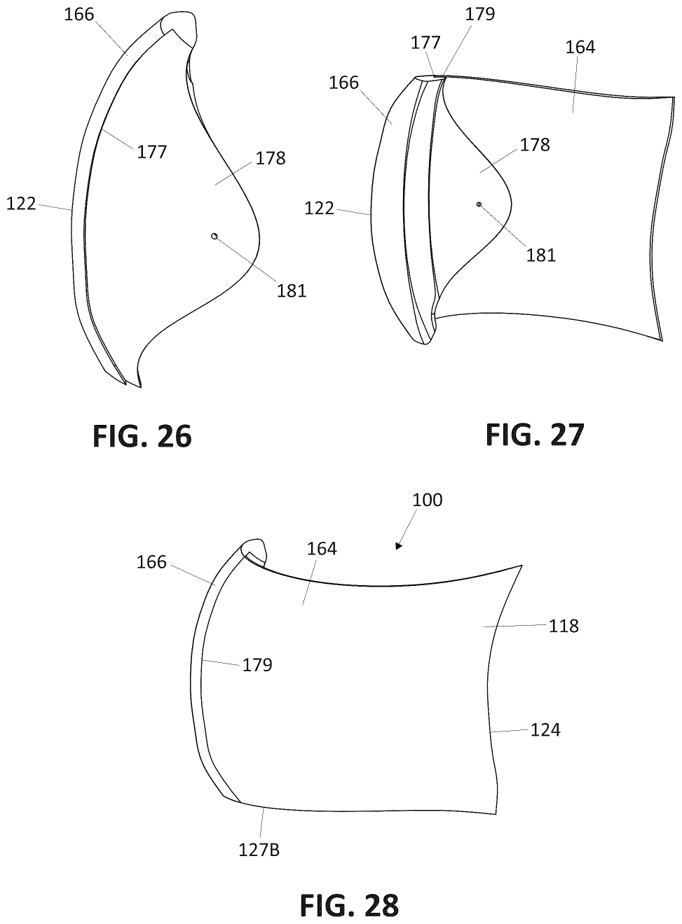

Referring now to FIGS. 26-28, yet another embodiment of the composite three-dimensional airfoil 100 is illustrated. In this embodiment, the airfoil 100 includes a second component 166 disposed along a leading edge region of the blade, with aft portions of the airfoil blade being defined primarily by a first component 164. This configuration allows the second component 166 to assume a primary aerodynamic role at a leading edge 122 of the airfoil 100, while the structural properties and support for the remainder of the blade are maintained by the first component 164.

As best shown in FIG. 26, the second component 166 can define a compound curved leading edge 122 that serves as an aerodynamic nose of the airfoil 100. This leading edge 122 can exhibit curvature along both the chordwise (x-axis) and spanwise (y- or z-axis) directions to optimize airflow characteristics. Extending aft of the leading edge 122, the second component 166 can further define a chamfer portion 178, which tapers rearward and blends with an outer surface of the first component 164. The chamfer portion 178 imparts an acrodynamic blade chamfer that would otherwise be unachievable using the first component 164 alone, which is typically formed from a sheet of uniform thickness. The second component 166 thus provides additional depth and shaping flexibility near the leading edge region to improve airflow control and reduce drag.

The second component 166 also defines a similarly compound curved channel or recess 177 into which a correspondingly shaped leading edge portion 179 of the first component 164 can be inserted. Once positioned, the first component 164 can be mechanically retained within the channel 177 via adhesive bonding, friction fit, thermal welding, or mechanical interlocks, thereby forming a unified composite airfoil structure 100 with a continuous aerodynamic surface. In some embodiments, the second component 166 may define one or more connection features 181, such as apertures or adhesive ports, to facilitate the introduction of bonding agents or mechanical coupling to the first component 164 during assembly. These features 181 can also assist in alignment or serve as through-voids for ventilation or tooling purposes during manufacturing.

In some embodiments, the second component 166 may also partially wrap around the top and/or bottom surfaces of the first component 164, providing additional surface area for bonding and enhancing structural stability. This front-loaded configuration places the more easily formable second material in a region of high aerodynamic significance, allowing intricate nose shaping without requiring extensive deformation of the stiffer first component 164.

The first component 164 may be constructed from a metallic material selected for its structural integrity and stiffness. Examples include aluminum, steel, or their respective alloys, as described above. These materials are well-suited to bear the mechanical loads imparted during fan operation, particularly in high-speed or high-pressure environments. Conversely, the second component 166 may be formed from a moldable, nonstructural material, such as a polymer, composite, or resin-based compound that is amenable to shaping and bonding. In some embodiments, the second material may possess thermoplastic or thermoset properties, with optional binding or curing characteristics to facilitate adhesion during assembly.

The embodiment shown in FIGS. 26-28 thus enables refined shaping of the leading edge 122 to improve aerodynamic performance while reducing overall production complexity. Compared to the embodiment shown in FIGS. 17-19, this configuration can achieve an approximately 60% reduction in the amount of material used to form the second component 166. This reduction in material volume contributes to overall weight and cost savings without sacrificing aerodynamic efficiency, making the design particularly advantageous in applications requiring lightweight, high-performance airflow control. By concentrating the moldable material at the leading edge, the system maintains performance while reducing material waste and simplifying the manufacturing process.

In some embodiments, the second component 166 may be formed as a modular or replaceable structure configured to interface with corresponding retention features defined by the first component 164. For example, the first component 164 may define one or more receiving channels, slots, notches, or undercut grooves shaped to accept a preformed second component 166 with a complementary geometry. The second component 166 can include mating features such as tabs, flanges, flexible barbs, or dovetail projections that engage with corresponding mechanical receptacles in the first component 164. In other embodiments, the first and second components may be mechanically joined via snap-fit features, twist-lock mechanisms, captive fasteners, or detents that resist axial or radial displacement during operation. Where enhanced retention is desired, the coupling interface may incorporate interference fits, spring-loaded clamps, or crimped engagement regions that deform slightly during assembly to produce a secure bond. Additionally, locating pins or alignment bosses can be provided on one component to ensure repeatable positioning and accurate assembly of the aerodynamic contours. These mechanical engagement features may optionally be supplemented with adhesive bonding, spot welding, or thermal fusion at specific locations to improve long-term retention or resistance to vibration and thermal cycling. This modular configuration allows for field-level replacement or customization of the second component 166 while preserving the structural integrity provided by the first component 164.

### Concept III

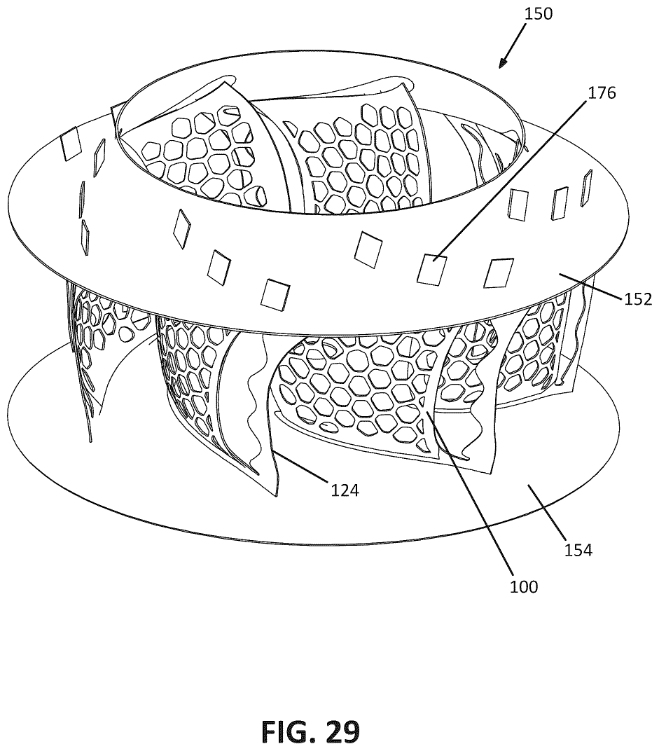

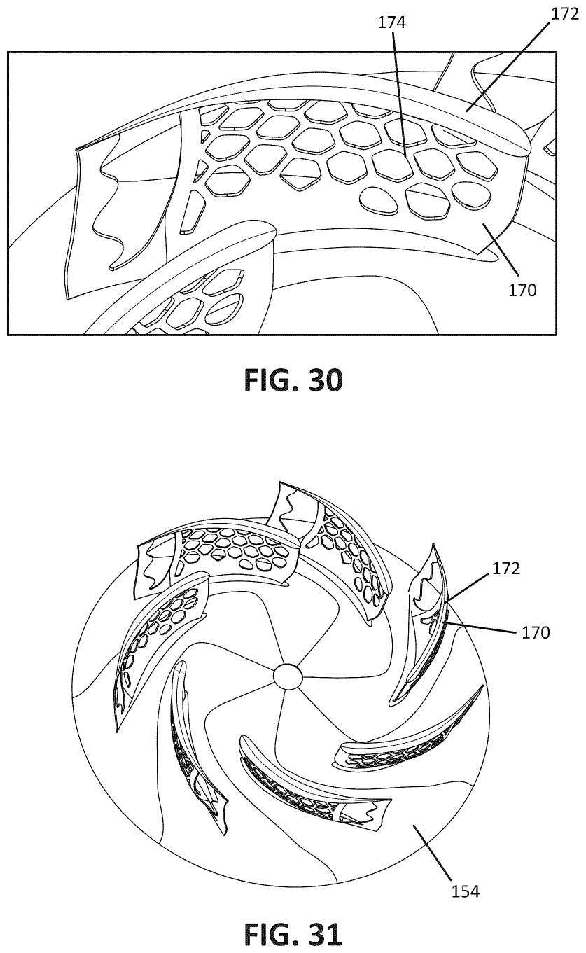

Referring to FIGS. 29-31, a depiction of a fan wheel 150 is provided, incorporating a composite airfoil 100 having a strut 170 and blade body 172. In embodiments, the strut 170 can serve as an insert within a mold, around which a blade body 172 is molded, effectuating a precise fitting between the strut 170 and the blade body 172. The strut 170, can be fabricated from a first material, such as thin metal sheet, including aluminum, steel, or their alloys, can act as a structural framework supporting the construction of the three-dimensional, nonstructural blade body 172.

In some embodiments, the blade body 172, which can be constructed of a second, moldable material, can completely or partially encapsulate the strut 170, thus serving as a protective layer against hazardous environmental conditions. This encapsulation can allow for the airfoils 100 to exhibit design flexibility, enabling the creation of shapes on both sides of the airfoil that might otherwise be challenging or cost-prohibitive to achieve through conventional metal forming techniques. Moreover, the description of the first and second materials in the embodiment depicted in FIGS. 16-28, respectively serving as structural and non-structural materials, is equally applicable to this embodiment.

To enhance the adhesion between the strut 170 and the blade body 172, the strut 170 may incorporate one or more structural features 174, such as cutouts or webbing, which may also define one or more voids. These features can be configured to facilitate the bonding of the blade body 172 to the strut 170, ensuring a robust and durable assembly. In some embodiments, the one or more structural features 174 can define one or more voids, which can serve to house balancing weights, RFID chips, mechanical actuators, sensors, or other functional elements.

In some embodiments, the blade body 172 can be overmolded onto the strut 170 using an injection molding process, wherein the strut 170 functions as an insert component positioned within the mold cavity. During molding, the second, moldable material is injected around the strut 170 and flows through the one or more structural features 174 defined by the strut 170. These structural features 174 can be formed as through-holes, voids, or cellular openings that allow the injected material to pass through and mechanically interlock with the strut 170, thereby enhancing adhesion and structural coupling between the blade body 172 and the strut 170. In some embodiments, the structural features 174 can be configured as relatively small cells near the leading edge of the airfoil 100 to maintain rigidity and aerodynamic precision in that region. In contrast, the structural features 174 can be configured as relatively large cells near the trailing edge of the airfoil 100, where material thickness of the strut 170 may be reduced or discontinuous due to geometric tapering of the blade. This variation in cell size enables optimized material distribution and ensures robust overmolding performance while maintaining aerodynamic and structural efficiency throughout the airfoil profile.

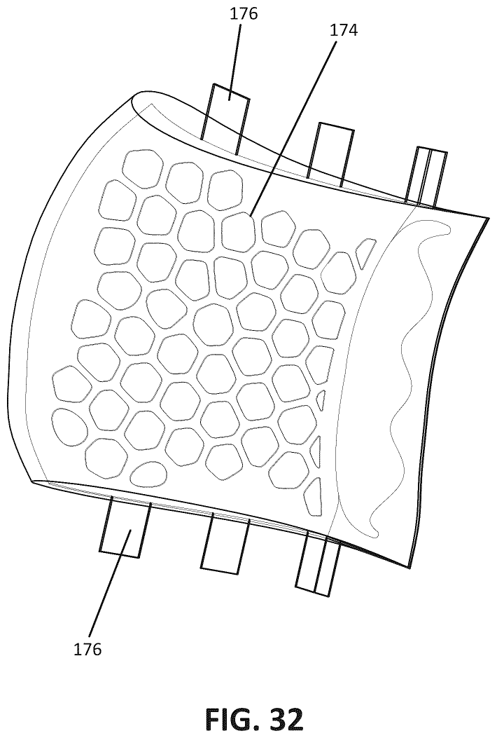

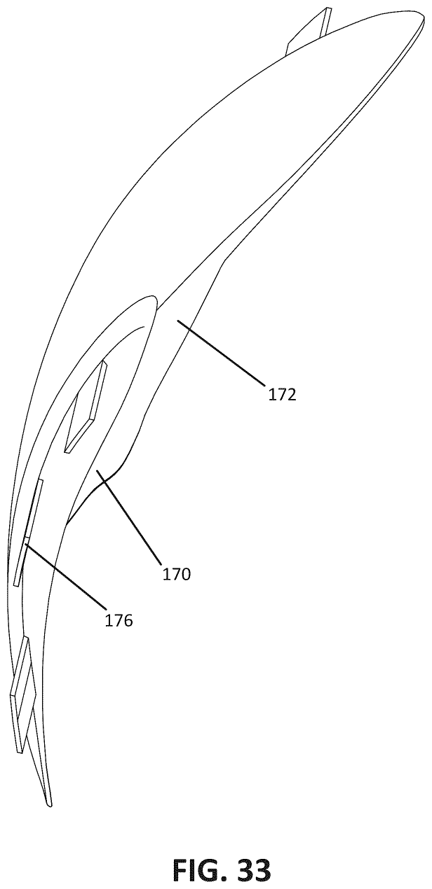

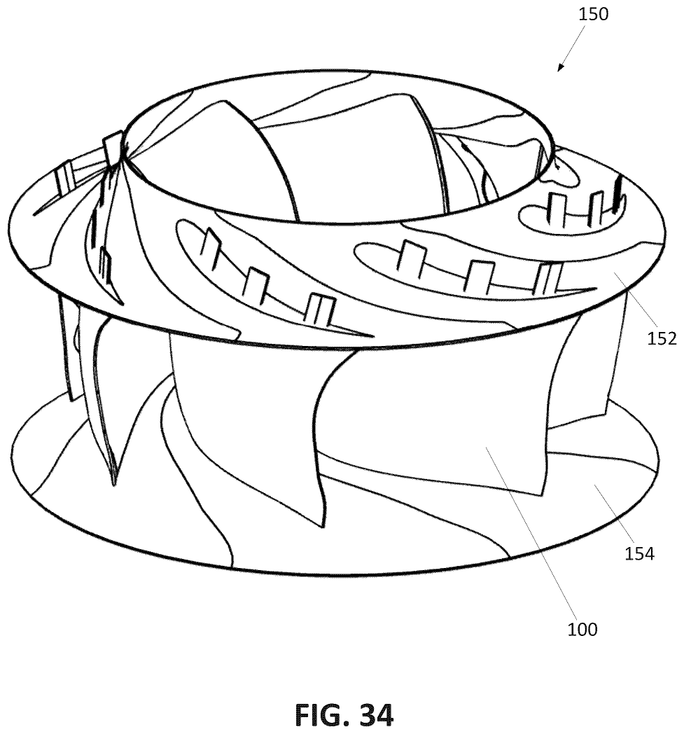

For mechanical integration into the fan wheel 150 (as illustrated in FIG. 32), the strut 170 can be equipped with one or more tabs 176. The tabs 176 can be designed to engage with specific portions of the wheel shroud 152 and the wheel hub 154, providing a secure method of attaching the airfoils 100 to the fan assembly. This connection mechanism not only simplifies the assembly process but also ensures the structural integrity and operational reliability of the fan wheel 150.

Embodiments of the composite airfoil 100 leverage the strengths of both metallic and non-metallic materials to achieve a composite airfoil structure that is both versatile and performance-oriented. By fully encapsulating the structural strut 170 within the blade body 172, the airfoil 100 offers enhanced protection and design freedom, enabling complex airfoil configurations that optimize aerodynamic efficiency while minimizing manufacturing complexity and cost.

### Concept IV

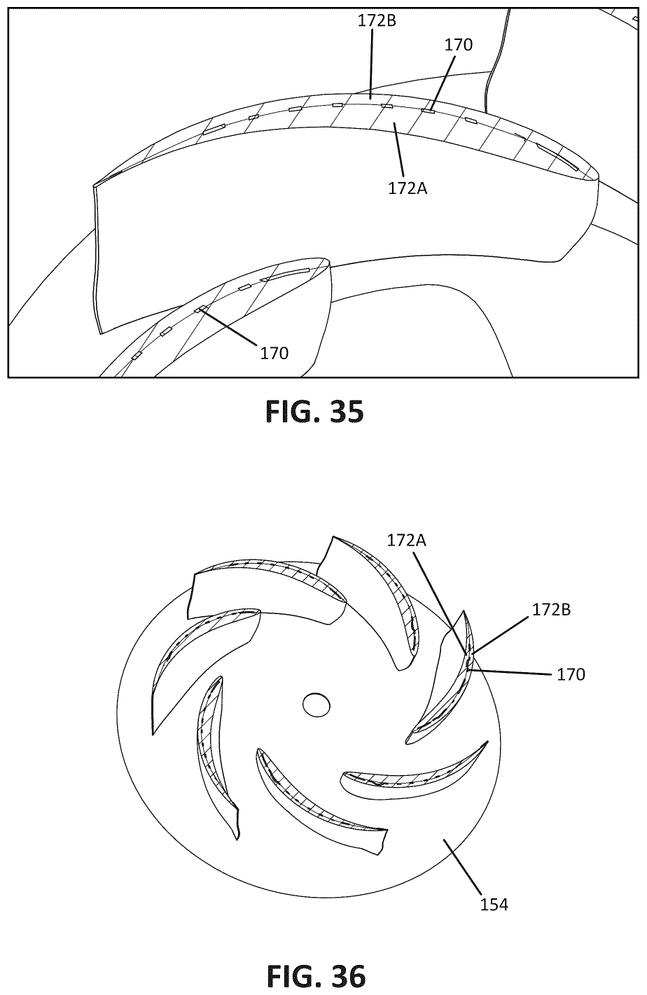

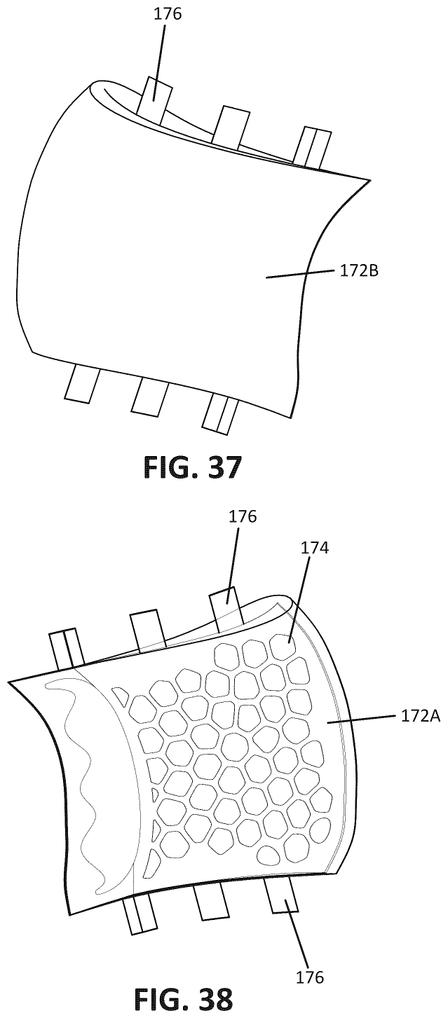

Referring to FIGS. 34-39, a depiction of a fan wheel 150 is provided, incorporating a composite airfoil 100 that includes a strut 170 and a two-piece clamshell blade body 172A, 172B. In these embodiments, the strut 170 functions as structural support, around which the blade body components 172A, 172B are mechanically affixed, positioned on either side of the strut 170. The strut 170, which can be constructed from a first, structural material such as thin metal sheets, inclusive of aluminum, steel, or their alloys, serves as the structural backbone that supports the blade body 172A, 172B, which can constructed of a second, non-structural material as defined above. The description of the first and second materials in the embodiment depicted in FIGS. 16-25 and 25-30, respectively serving as structural and non-structural materials, is equally applicable to this embodiment.

In some embodiments, the blade body 172A, 172B, which can be constructed from the second material, may entirely or partially encapsulate the strut 170, thereby potentially acting as a shield or barrier for the strut 170. This encapsulation grants the airfoil 100 enhanced design versatility, facilitating the fabrication of aerodynamic shapes that may be unattainable or economically infeasible with standard metal forming methods.

The strut 170 can include one or more structural features 174, such as cutouts or webbing, intended to improve the cohesion between the strut 170 and the blade bodies 172A, 172B. These features 174 can be designed to promote the secure attachment of the blade body 172A, 172B to the strut 170. In some embodiments, the one or more structural features 174 can define one or more voids, which can serve to house balancing weights, RFID chips, mechanical actuators, sensors, or other functional elements.

The composite airfoil 100 also permits the hollowing of the blade body 172A, 172B. For instance, each segment of the blade body can incorporate structural supports that define voids. These voids can serve as repositories for balance weights, sensors, identification chips, and other functional components, thus enhancing the blade's utility. Functionally, the blade bodies 172A, 172B can be designed to minimize material usage, contributing to a lightweight construction.

For integration into the fan wheel 150 (as depicted in FIG. 34), the strut 170 can be equipped with tabs 176 to interact with designated areas of the wheel shroud 152 and the wheel hub 154, offering a method for securing the airfoils 100 to the wheel shroud 152 and the wheel hub 154.

The embodiments of the composite airfoil 100 utilize a combination of metallic and non-metallic materials to craft a blade structure that is adaptable and focused on performance. This innovative approach enables the retrofitting of single-thickness bladed fans with Concept IV blades to enhance efficiency, providing a practical upgrade solution.

In certain embodiments, the blade body components 172A and 172B can be mechanically coupled to the strut 170 using integrated attachment mechanisms designed to facilitate case of assembly, structural integrity, and acrodynamic continuity. For example, one or both blade body components 172A, 172B may define inward-facing flanges, clips, or recessed channels configured to interlock with corresponding features on the strut 170, such as edge tabs, detents, or barbed ribs. The blade body components may also include perimeter engagement features—such as tongue-and-groove joints, alignment pins, or stepped edges—that allow the two clamshell halves to self-align and lock together around the strut 170. In some embodiments, fastening may be achieved via thermal staking, ultrasonic welding, rivets, or adhesive bonding, depending on the material system and operational requirements. These features also enable modular disassembly for inspection, repair, or replacement of either the structural strut 170 or the aerodynamic skin formed by blade body components 172A and 172B.

Incorporation into Assemblies

In some embodiments, the airfoils 100 can be incorporated into a centrifugal fan, such as that depicted in the fan wheel assembly 150 of FIGS. 1, 10, and 11. For example, the airfoil blades can be mechanically coupled between the wheel shroud 152 and the wheel hub 154, with a designated space separating the two components. In other embodiments, an airfoil constructed according to the methods described herein can be incorporated into various types of air movement devices used in HVAC systems including, but are not limited to, axial fans, mixed-flow fans, and cross-flow fans. The design and manufacturing techniques of the airfoil blades described herein make the airfoils suitable for a wide range of applications, providing improved airflow characteristics and energy efficiency in each type of fan assembly.

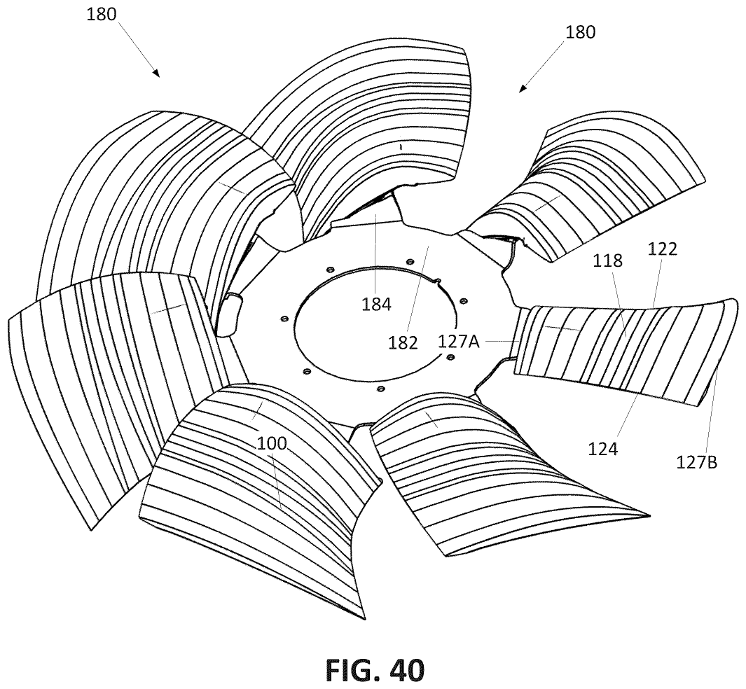

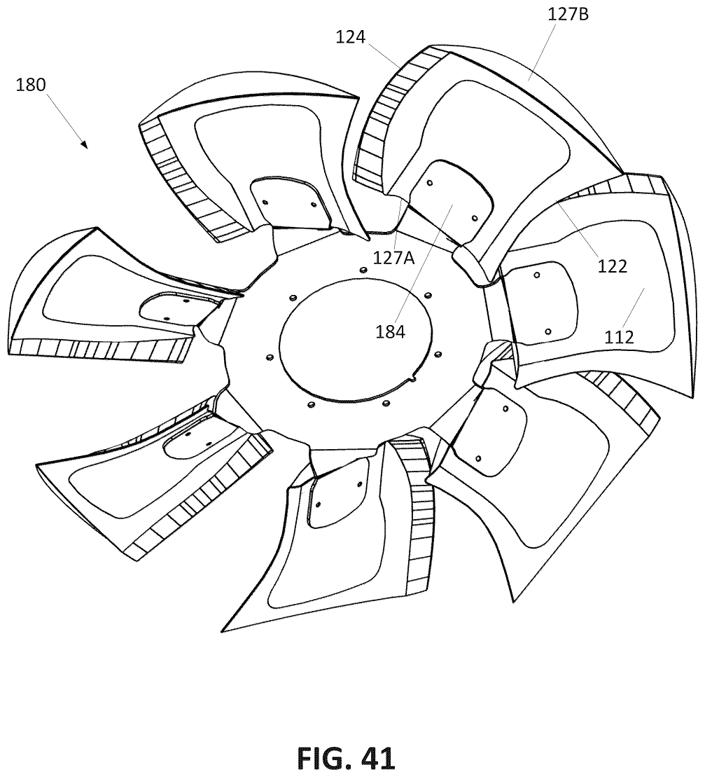

For example, as depicted in FIGS. 40-41, an axial fan assembly 180 including a plurality of airfoils 100 is depicted in accordance with an embodiment of the disclosure. Each airfoil 100 can be constructed according to the techniques disclosed herein, including a stamped metal airfoil assembly technique, such as that depicted in FIGS. 2-15, or an airfoil comprising a composite structural and nonstructural structure, such as that depicted in FIGS. 9, 19, 22, 25, 28, 32, and 38, ensuring that the airfoil blades maintain their acrodynamic efficiency and structural integrity under various operational conditions.

The general structure of each airfoil 100 can include an inside surface 112 featuring a first three-dimensional shape 114, and an outside surface 118 with a second three-dimensional shape 120. The combined inside and outside surfaces 112, 118 can be bounded by a leading edge 122, a trailing edge 124, a top edge 127A, and a bottom edge 127B, enabling a smooth airflow over the surfaces to enhance the efficiency of the fan assembly.

As further depicted in FIGS. 40-41, in some embodiments, each airfoil 100 can be operably coupled to an axial fan wheel hub 182. For example, in one embodiment, the axial fan wheel hub 182 can define a plurality of airfoil spokes 184 to which the inside surface 112 of each of a plurality of airfoils 100 can be mechanically coupled. To achieve a desired angle of attack for each of the plurality of airfoils 100, in some embodiments, each of the plurality of airfoil spokes 184 can define a neck portion including a rotational twist terminating in an wider airfoil contact portion, to which an airfoil 100 can be riveted.

In other embodiments, one or more tabs 176 (such as that depicted in FIG. 32) can protrude from either the top edge 127A or the bottom edge 127B for coupling to the axial fan wheel hub 182. For example, in some embodiments, the axial fan wheel hub 182 can define a plurality of airfoil spokes 184 configured to mate with the tabs 176 defined by each of the airfoils 100. This configuration ensures secure attachment and proper alignment of the airfoil blades within the axial fan assembly. Other mechanisms for coupling the airfoils 100 to the axial fan wheel hub 182 are also contemplated.

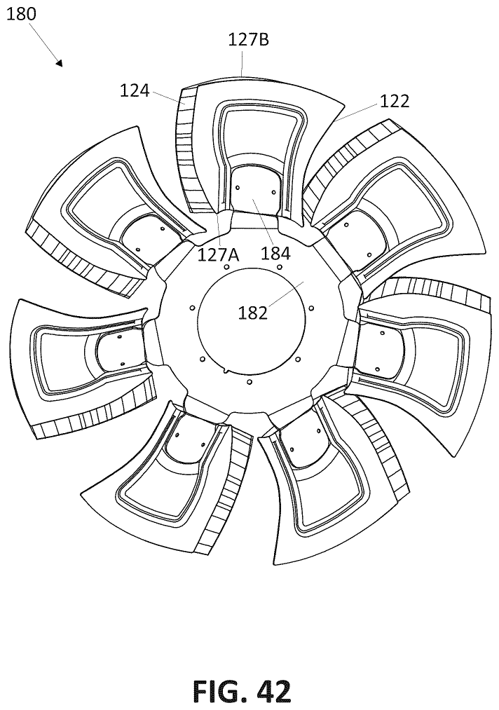

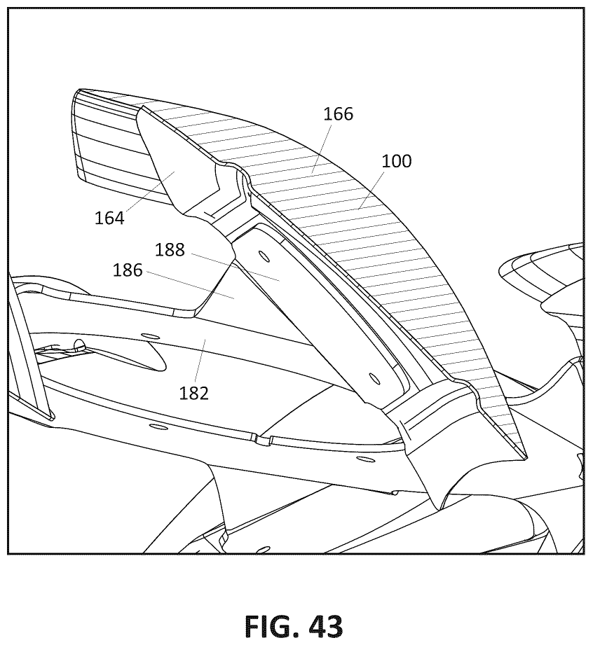

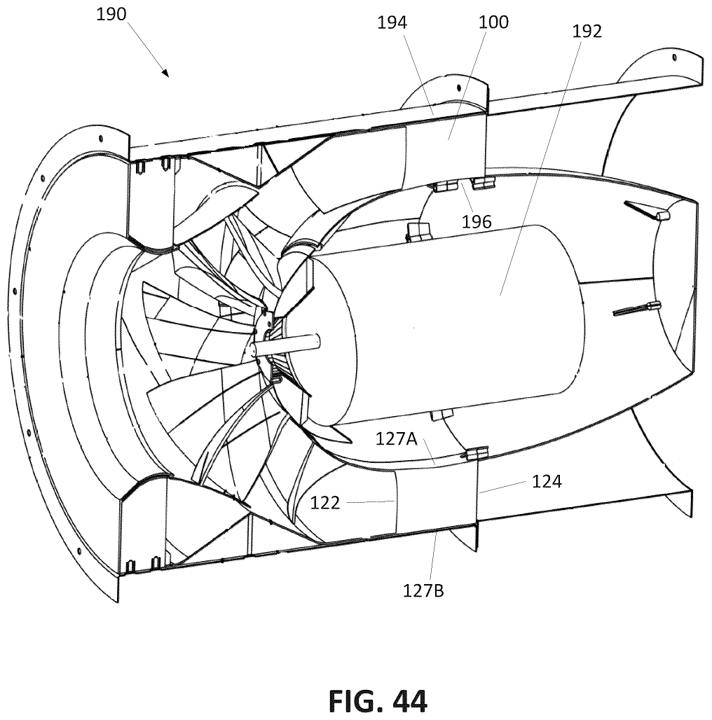

Referring now to FIGS. 42 and 43, yet another embodiment of an axial fan wheel hub 180 is illustrated. This embodiment includes an axial fan wheel hub 182 configured to mechanically couple to a plurality of airfoils 100 arranged circumferentially about the axial fan wheel hub 182. As shown in FIG. 42, the axial fan wheel hub 182 can define a plurality of radial spoke elements 184 extending outward from the axial fan wheel hub 182. Each spoke element 184 can include a neck portion 186 extending radially outward from the axial fan wheel hub 182 and terminating in an airfoil interface portion 188.

In some embodiments, the airfoil interface portion 188 can include an angled or twisted mounting surface configured to define a desired pitch or angle of attack for each airfoil 100. The corresponding airfoil 100 can be contoured or recessed to receive the airfoil interface portion 188, enabling secure mechanical coupling between each airfoil and the axial fan wheel hub 180. In other embodiments, the airfoil 100 may include additional fastening features such as rivets, weld points, or interlocking projections to engage with the airfoil interface portion 188, thereby ensuring robust attachment under high-speed rotational loading.

As shown in FIG. 43, the airfoil 100 may include a first component 164 and a second component 166. In such cases, the first component 164 may define a structural backbone, while the second component 166 defines a conformal outer shell or aerodynamic contour. The first component 164 may be mechanically fastened or bonded to the airfoil interface portion 188 of the spoke element 184, while the second component 166 is molded or affixed in place to form a cohesive airfoil structure. In some embodiments, the first component 164 is formed from a thin metal sheet that can be stamped, bent, or otherwise shaped to include one or more structural ridges 171, corrugations, or contours that extend along a chordwise or spanwise direction of the airfoil. These features 171 can enhance the stiffness, torsional resistance, or vibration damping characteristics of the first component 164 without significantly increasing its weight or thickness, thereby improving mechanical performance under centrifugal loads and high-speed airflow conditions.

This embodiment of the axial fan wheel hub 180 enables flexible integration with a variety of airfoil constructions, including full polymer airfoils, partially encapsulated structural inserts, or multi-material hybrid blade bodies. The design of the spoke elements 184 allows for a consistent pitch angle and even blade spacing, while the combination of structural and aerodynamic materials in the airfoils 100 promotes both mechanical durability and energy-efficient airflow through the fan assembly.

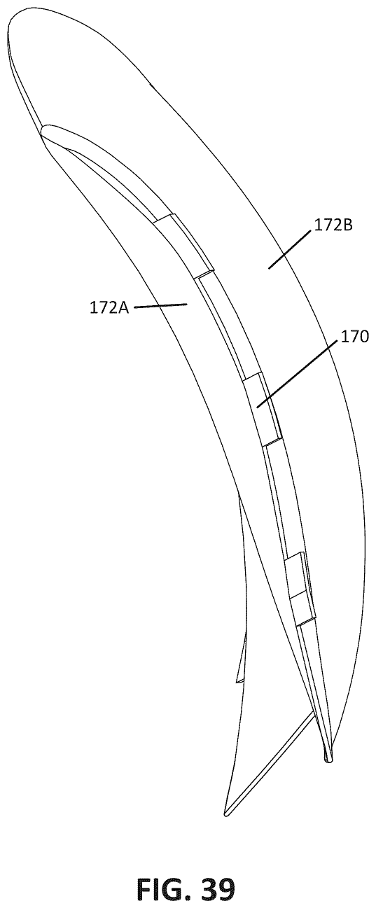

In some embodiment, the airfoils 100 can be incorporated as a nonmoving strut or stator blade, for example to support a motor, drive train, or housing. For example, as depicted in FIG. 39, a fan assembly 190 including one or more airfoils 100 serving as a stator blade to support a motor 192 is depicted in accordance with an embodiment of the disclosure.

The general structure of each airfoil 100 can include a first surface featuring a first three-dimensional shape, and a second surface featuring a second three-dimensional shape. The combined first and second surfaces can be bounded by a leading edge 122, a trailing edge 124, a top edge 127A, and a bottom edge 127B, enabling smooth airflow over the surfaces.

As further depicted in FIG. 39, the airfoils 100 can serve as a structural stator blade members, for example, between a fan assembly housing 194 and a motor housing 196 to support the motor 192. This arrangement not only stabilizes the motor but also guides the airflow through the fan assembly, improving cooling and reducing turbulence. The integration of airfoil blades as stators thus contributes to the mechanical integrity and aerodynamic efficiency of the fan assembly. In embodiments, the motor 192 can be configured to power a fan wheel 150, or axial fan assembly 180, formed using any of the processes described herein.

Other uses of the airfoils 100 are also contemplated. For instance, the airfoil blades could be utilized in HVAC systems as part of the ductwork to direct and manage airflow, or in other industrial applications where precise airflow control and structural support are required. The versatility and effectiveness of the airfoil blade design make it suitable for a wide range of applications beyond those specifically illustrated, offering potential improvements in efficiency and performance across various systems.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

Various embodiments of the present disclosure will be described in detail with reference to the drawings, where like reference numerals represent like parts and assemblies throughout the several views. Reference to various embodiments does not limit the scope of the invention, which is limited only by the scope of the claims attached hereto. Additionally, any example set forth in the specification is not intended to be limiting and merely sets forth some of the many possible embodiments for the claimed invention.

What is claimed is:

1. A fan wheel comprising:
a central hub; and
a plurality of airfoil blades extending from the central hub, wherein each airfoil blade defines a three-dimensional aerodynamic profile having a first camber surface and an oppositely facing second camber surface, each airfoil blade including:
a first component defining at least a portion of the first camber surface of the airfoil blade; and
a second component defining at least a portion of the second camber surface of the airfoil blade, the second component being joined to the first component.

2. The fan wheel of claim 1, wherein the three-dimensional aerodynamic profile includes a first three-dimensional shape corresponding to the first camber surface and a second three-dimensional shape corresponding to the second camber surface, and wherein both the first three-dimensional shape and the second three-dimensional shape are characterized by a compound curvature defining respective inside and outside curves along both a length and a width of the airfoil.

3. The fan wheel of claim 1, wherein the first component and the second component are stamped to respectively form the portions of the first and second camber surfaces.

4. The fan wheel of claim 3, wherein the first and second components are formed from a metal material.

5. The fan wheel of claim 1, wherein second component is joined by welding to the first component.

6. The fan wheel of claim 1, wherein the second component is formed from a polymeric material.

7. The fan wheel of claim 1, wherein the second component at least partially surrounds the first component.

8. The fan wheel of claim 1, wherein the first component and the second component are joined by an interlocking mechanism comprising at least one of a cutout, a tab, and a webbing structure.

9. The fan wheel of claim 1, wherein the second component includes one or more apertures extending through a thickness of the second component.

10. The fan wheel of claim 1, wherein the first component includes one or more tabs configured to facilitate mechanical engagement with at least one of a wheel shroud, a wheel hub, or a wheel cone.

11. The fan wheel of claim 1, wherein one or both of the first and second camber surfaces is provided with distinct surface textures contributed by both the first component and the second component to enhance airflow characteristics across an external surface of the airfoil.

12. The fan wheel of claim 1, wherein the fan wheel is configured as at least one of a centrifugal fan, an axial fan, or a mixed-flow fan.

13. A fan wheel comprising:
a central hub; and
a plurality of airfoils extending radially outward from the central hub,
wherein each airfoil comprises:
a first component formed by stamping a first metal blank to define an inside surface of the airfoil having a first three-dimensional shape;
a second component formed by stamping a second metal blank to define an outside surface of the airfoil having a second three-dimensional shape;
wherein the first component and the second component are shaped to align with one another along at least a leading edge of the airfoil; and
wherein the first component and the second component are joined to one another along the leading edge and a trailing edge of at least one of the first component or the second component to cooperatively form a three-dimensional aerodynamic profile of the airfoil.

14. The fan wheel of claim 13, wherein the first three-dimensional shape and the second three-dimensional shape are each characterized by a compound curvature defining respective inside and outside curves along both a length and a width of the airfoil.

15. The fan wheel of claim 13, wherein the first metal blank and the second metal blank are each formed from a material suitable for stamping into a complex three-dimensional shape.

16. The fan wheel of claim 15, wherein the material suitable for stamping includes aluminum, steel, or an alloy thereof.

17. A fan wheel comprising:
a central hub; and
a plurality of airfoils extending radially outward from the central hub,
wherein each airfoil comprises:
a first component composed of a first material;
a second component composed of a second material different from the first material and configured to assume a three-dimensional shape;
wherein the second component is configured to mechanically couple with the first component through an interlocking mechanism; and
wherein the first component and the second component are joined to form a composite airfoil structure defining a three-dimensional aerodynamic profile.

18. The fan wheel of claim 17, wherein the interlocking mechanism comprises at least one of a cutout, tab, or webbing formed on the first component or the second component.

19. The fan wheel of claim 17, wherein the second component defines one or more voids.

20. The fan wheel of claim 17, wherein the first component includes one or more tabs configured to facilitate mechanical engagement with at least one of a wheel shroud, a wheel hub, or a wheel conc.
